(19) United States
(12) Patent Application Publication
(10) Pub. No.: US 2017/0343838 A1
(43) Pub. Date: Nov. 30, 2017

(54) SYSTEM AND METHOD FOR MANUFACTURING OPTICAL DISPLAY ELEMENT

(71) Applicant: LG CHEM, LTD., Seoul (KR)

(72) Inventors: Beom Seok LEE, Daejeon (KR); Suk Jae Lee, Daejeon (KR); Kyung Hyeok Park, Daejeon (KR); San Park, Daejeon (KR); Hang Suk Choi, Daejeon (KR); Eung Jin Jang, Daejeon (KR); Bong Su Jeung, Daejeon (KR); Jea Han Ryoo, Daejeon (KR)

(21) Appl. No.: 15/604,391

(22) Filed: May 24, 2017

(30) Foreign Application Priority Data
May 30, 2016 (KR) 10-2016-0066197

(51) Int. Cl. G02F 1/13; B32B 37/14; G02F 1/1335

(52) U.S. Cl. CPC G02F 1/1303; G02F 1/133528; B32B 37/14; B32B 2307/42; G02F 2001/133531

(57) ABSTRACT

According to the present invention, a system for manufacturing an optical display element, which manufactures an optical display element by laminating optical films on both planes of a rectangular panel according to the present invention includes: a panel supply unit supplying the panel; a first laminating unit laminating a first optical film onto the panel in a first direction selected from a long-edge longitudinal direction and a short-edge longitudinal direction of the panel at a first side selected from the two sides of the panel; a second laminating unit laminating a second optical film onto a plane opposite to the plane onto which the first optical film is laminated in a second direction selected from the long-edge longitudinal direction and the short-edge longitudinal direction of the panel and different from the first direction; and a first reverse unit reversing, when a first laminating plane onto which the first optical film is laminated is selected from between one plane and the other plane of the panel and predetermined as a process condition, the panel to reverse positional relationships of the planes of the panel if the first laminating plane is different from a plane of the panel supplied by the panel supply unit at the first side of the panel.

### TECHNICAL FIELD

The present invention relates to a system and a method for manufacturing an optical display element, and more particularly, to a system and a method for manufacturing an optical display element, which can manufacture a plurality of types of optical display elements by a single manufacturing line.

### BACKGROUND ART

In general, a liquid crystal panel including liquid crystal cells is configured by disposing the liquid cells between a substrate disposed at a light source side and a substrate viewed by an observer.

In addition, the liquid crystal panel may be divided into a so called O mode liquid crystal panel and a so called E mode liquid crystal panel according to a correlation between an initial alignment direction of the liquid crystal cells and an absorption axis direction of a polarization plate laminated onto the substrate side disposed at the light source side.

Meanwhile, a manufacturing system that manufactures the optical display element by laminating optical films on both planes of a rectangular liquid crystal panel in the related art includes an apparatus that laminates the optical film formed on a width corresponding to a long edge of the liquid crystal panel and an apparatus that laminates the optical film formed on a width corresponding to a short edge of the liquid crystal panel and is configured in such a manner that one of the respective laminating apparatuses is laminated only to the substrate disposed at the light source side and the other one is laminated only to the substrate viewed by the observer.

The optical display element manufacturing system in the related art has a problem in that only one mode liquid crystal panel of the O mode liquid crystal panel and the E mode liquid crystal panel associated with a direction in which the optical film is laminated to the light source side cannot but be manufactured.

### DETAILED DESCRIPTION OF THE INVENTION

### Technical Problem

The present invention is contrived to solve the problem and an object of the present invention is to provide a method and a system for manufacturing an optical display element, which can manufacture a plurality of optical display elements of a type in which laminating directions are different from each other by a single manufacturing line based on one plane of a panel.

### Technical Solution

An exemplary embodiment of the present invention provides a system for manufacturing an optical display element, which manufactures an optical display element by laminating optical films on both planes of a rectangular panel, including: a panel supply unit supplying the panel; a first laminating unit laminating a first optical film onto the panel in a first direction selected from a long-edge longitudinal direction and a short-edge longitudinal direction of the panel at a first side selected from the two sides of the panel; a second laminating unit laminating a second optical film onto a plane opposite to the plane onto which the first optical film is laminated in a second direction selected from the long-edge longitudinal direction and the short-edge longitudinal direction of the panel and different from the first direction; and a first reverse unit reversing, when a first laminating plane onto which the first optical film is laminated is selected from between one plane and the other plane of the panel and predetermined as a process condition, the panel to reverse positional relationships of the planes of the panel if the first laminating plane is different from a plane of the panel supplied by the panel supply unit at the first side of the panel.

Herein, according to the optical display element manufacturing system, in the optical display element, the panel may include liquid crystal cells and one plane of the panel may be disposed at a light source of the liquid crystal cells.

Herein, according to the optical display element manufacturing system, the optical film may include the polarization plate, and in the process condition, the first laminating plane may be set so that an initial alignment direction of the liquid crystal cells is parallel to the absorption axis direction of the polarization plate included in the optical film laminated onto one plane of the panel.

Herein, according to the optical display element manufacturing system, the optical film may include the polarization plate, and in the process condition, the first laminating plane may be set so that an initial alignment direction of the liquid crystal cells is orthogonal to the absorption axis direction of the polarization plate included in the optical film laminated onto one plane of the panel.

Herein, the system may further include a second reverse unit reversing the panel so as to the reverse directions toward which the planes of the panel onto which the first optical film is laminated face, before the second optical film is laminated onto the panel.

Herein, the system may further include a pivot unit pivoting the panel so as to reverse the positional relationships of a long edge and a short edge of the panel onto which the first optical film is laminated, before the second optical film is laminated onto the panel.

Herein, according to the optical display element manufacturing system, the pivot unit may pivot the panel around a pivot axis which is parallel to both planes of the panel and is not parallel to either of the long edge and the short edge of the panel so as to reverse directions which the planes of the panel onto which the first optical film is laminated face.

Herein, according to the optical display element manufacturing system, a first optical film sheet piece formed by unrolling the first optical film from a first film roll on which the first optical film which elongates is wound and cutting the first optical film in a width direction is laminated onto one plane of one plane of the planes of the panel, and a second optical film sheet piece formed by unrolling a second optical film from a second film roll on which the second optical film which has a different width from the first optical film and elongates is wound and cutting the second optical film in the width direction is laminated onto a plane opposite to the plane of the panel onto which the first optical film sheet piece is laminated to manufacture the optical display element.

Another exemplary embodiment of the present invention provides a method for manufacturing an optical display element, which manufactures an optical display element by laminating optical films on both planes of a rectangular panel, including: supplying the panel by a supply unit; laminating a first optical film onto the panel in a first direction selected from a long-edge longitudinal direction and a short-edge longitudinal direction of the panel at a first side at a first side selected from the two sides of the panel by a first laminating unit; laminating a second optical film onto a plane opposite to the plane onto which the first optical film is laminated in a second direction selected from the long-edge longitudinal direction and the short-edge longitudinal direction of the panel and different from the first direction by a second laminating unit; and reversing, when a first laminating plane onto which the first optical film is laminated between one plane and the other plane of the panel is previously set as a process condition, the panel to reverse positional relationships of the planes of the panel by a first reverse unit if the first laminating plane is different from a plane of the panel supplied by the panel supply unit at the first side of the panel.

Herein, according to the optical display element manufacturing method, in the optical display element, the panel may include liquid crystal cells and one plane of the panel may be disposed at a light source of the liquid crystal cells.

Herein, according to the optical display element manufacturing method, the optical film may include the polarization plate, and in the process condition, the first laminating plane may be set so that an initial alignment direction of the liquid crystal cells is parallel to the absorption axis direction of the polarization plate included in the optical film laminated onto one plane of the panel.

Herein, according to the optical display element manufacturing method, the optical film may include the polarization plate, and in the process condition, the first laminating plane may be set so that an initial alignment direction of the liquid crystal cells is orthogonal to the absorption axis direction of the polarization plate included in the optical film laminated onto one plane of the panel.

Herein, the method may further include reversing by the second reverse unit the panel so as to reverse directions toward which the planes of the panel onto which the first optical film is laminated face, before the second optical film is laminated onto the panel.

Herein, the method may further include pivoting the panel by a pivot unit so as to reverse the positional relationships of a long edge and a short edge of the panel onto which the first optical film is laminated, before the second optical film is laminated onto the panel.

Herein, according to the optical display element manufacturing method, in the pivoting, the pivot unit may pivot the panel around a pivot axis which is parallel to both planes of the panel and is not parallel to either of the long edge and the short edge of the panel so as to reverse directions toward which the planes of the panel onto which the first optical film is laminated face.

Herein, according to the optical display element manufacturing method, a first optical film sheet piece formed by unrolling the first optical film from a first film roll on which the first optical film which elongates is wound and cutting the first optical film in a width direction may be laminated onto one plane of the planes of the panel, and a second optical film sheet piece formed by unrolling a second optical film from a second film roll on which the second optical film which has a different width from the first optical film and elongates is wound and cutting the second optical film in the width direction may be laminated onto a plane opposite to the plane of the panel onto which the first optical film sheet piece to manufacture the optical display element.

### Advantageous Effects

In a system and a method for manufacturing an optical display element according to the present invention, when a set first laminating plane is different from a panel supply plane facing a first side between one plane and the other plane of the panel supplied by the panel supply unit, positional relationships of one plane and the other plane of the panel may be allowed to be reversed by a first reverse unit. Herein, since the first laminating plane is a process condition selectively set between one plane and the other plane of the panel according to the type of the optical display element to be manufactured, at least two types of optical display elements can be manufactured by a single manufacturing line.

### BRIEF DESCRIPTION OF DRAWINGS

FIG. 1 is a diagram illustrating two types of optical display elements which can be manufactured by a method and a system for manufacturing an optical display element according to an exemplary embodiment of the present invention.

FIG. 2 is a block diagram illustrating an example of a method for manufacturing an optical display element according to an exemplary embodiment of the present invention.

FIG. 3a is a schematic perspective view illustrating an example of manufacturing an A type optical display element by using the system for manufacturing an optical display element according to the exemplary embodiment of the present invention.

FIG. 3b is a schematic perspective view illustrating an example of manufacturing a B type optical display element by using the system for manufacturing an optical display element according to an exemplary embodiment of the present invention.

FIG. 3c is a schematic perspective view illustrating another example of manufacturing the A type optical display element by using the system for manufacturing an optical display element according to the exemplary embodiment of the present invention.

FIG. 3d is a schematic perspective view illustrating another example of manufacturing the B type optical display element by using the system for manufacturing an optical display element according to the exemplary embodiment of the present invention.

FIG. 4 is a block diagram illustrating an example of a method for manufacturing an optical display element according to fourth to third exemplary embodiments of the present invention.

FIG. 5a is a schematic perspective view illustrating an example of manufacturing an A type optical display element by using a system for manufacturing an optical display element according to the second exemplary embodiment of the present invention.

FIG. 5b is a schematic perspective view illustrating an example of manufacturing a B type optical display element by using the system for manufacturing an optical display element according to the second exemplary embodiment of the present invention.

FIG. 6a is a schematic perspective view illustrating an example of manufacturing the A type optical display element by using the system for manufacturing an optical display element according to the third exemplary embodiment of the present invention.

FIG. 6b is a schematic perspective view illustrating an example of manufacturing the B type optical display element by using the system for manufacturing an optical display element according to the third exemplary embodiment of the present invention.

FIG. 7a is a schematic perspective view illustrating an example of manufacturing the A type optical display element by using the system for manufacturing an optical display element according to the fourth exemplary embodiment of the present invention.

FIG. 7b is a schematic perspective view illustrating an example of manufacturing the B type optical display element by using the system for manufacturing an optical display element according to the fourth exemplary embodiment of the present invention.

### EXPLANATION OF REFERENCE NUMERALS AND SYMBOLS

100, 200, 300, 400: System for manufacturing optical display element
10: Panel supply unit
30: First reverse unit
50: First laminating unit
60: Second reverse unit
70, 70′: Pivot unit
W: Panel
P1: One plane of panel
P2: The other plane of panel
F1: First optical film
F2: Second optical film

### BEST MODE

Hereinafter, exemplary embodiments of the present invention will be described in detail so as to be easily implemented by those skilled in the art, with reference to the accompanying drawings. However, the present invention can be realized in various different forms, and is not limited to the exemplary embodiments described herein. In addition, a part not related with a description is omitted in order to clearly describe the present invention in the drawings and throughout the specification, like reference numerals designate like elements.

Terms used in the present invention adopt general terms which are currently widely used as possible by considering functions in the present invention, but the terms may be changed depending on an intention of those skilled in the art, a precedent, and emergence of new technology. Further, in a specific case, a term which an applicant arbitrarily selects is present and in this case, a meaning of the term will be disclosed in detail in a corresponding description part of the invention. Accordingly, a term used in the present invention should be defined based on not just a name of the term but a meaning of the term and contents throughout the present invention.

A singular form may include a plural form if there is no clearly opposite meaning in the context. Throughout the specification and the claims, unless explicitly described to the contrary, the word “comprise” and variations such as “comprises” or “comprising” will be understood to imply the inclusion of stated elements but not the exclusion of any other elements.

Hereinafter, the present invention will be described in detail with reference to the accompanying drawings.

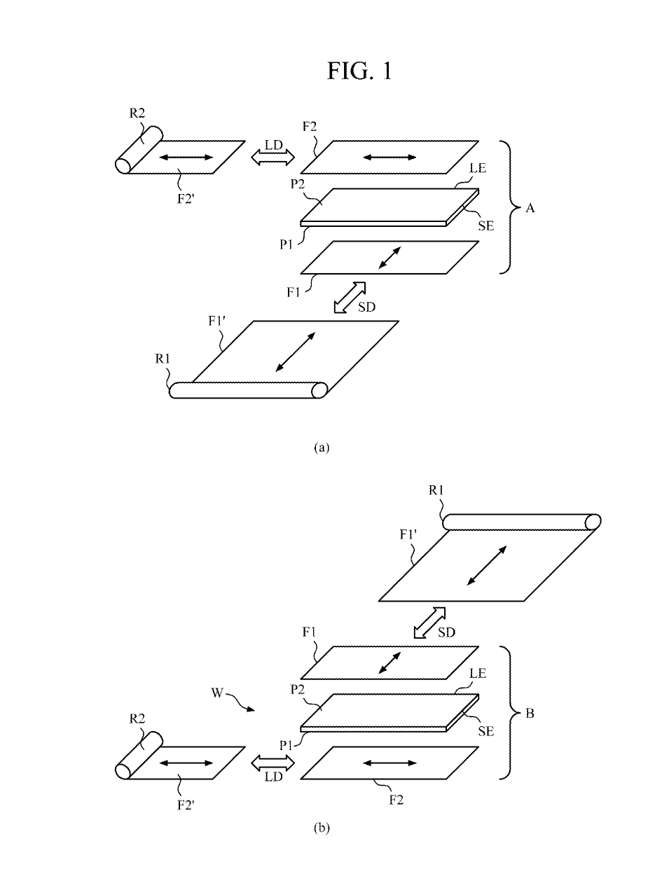

FIG. 1 is a diagram illustrating two types of optical display elements which can be manufactured by a method and a system for manufacturing an optical display element according to an exemplary embodiment of the present invention.

A panel W used in an optical display element manufactured by the present invention is a liquid crystal panel and may be a glass substrate unit in which a liquid crystal is positioned between a pair of glass substrates facing each other. Herein, the panel W may have a rectangular shape in which a long edge LE and a short edge are substantially orthogonal to each other.

In one plane P1 and the other plane P2 of the panel W, for convenience, a substrate disposed at a light source side of a liquid crystal cell of the pair of glass substrates will be described as one plane P1 of the panel W and a substrate viewed by an observer of the optical display element will be described as other plane P2 of the panel W.

The optical display element manufactured by the present invention may be classified into two types A and B according to whether a laminating direction in which an optical film (a sheet piece of the optical film) is laminated in any one direction of a long edge LE length direction of the panel W and a short edge SE length direction of the panel W is the long edge LE length direction or the short edge SE length direction based on one plane P1 of the panel W.

Hereinafter, based on one plane P1 of the panel W, the optical display element manufactured by laminating the optical film (the sheet piece of the optical film) in the short edge SE length direction will be described as an A type optical display element A and an optical display element manufactured by laminating the optical film (the sheet piece of the optical film) in the long edge LE length direction will be described as a B type optical display element B.

Herein, according to a type of optical display element to be manufactured, when the laminating direction in which the optical film (the sheet piece of the optical film) is laminated on one plane P1 of the panel W is determined as any one direction of the long edge (LE) longitudinal direction and the short edge (SE) longitudinal direction, the laminating direction in which the optical film (the sheet piece of the optical film) is laminated on the other plane P2 of the panel W may be determined as a different direction from the direction in which the optical film is laminated on one plane P1 of the panel W of the long edge (LE) longitudinal direction and the short edge (SE) longitudinal direction.

In the present invention, optical films F1′ and F2′ laminated on the panel W are elongated and two types of optical films F1′ and F2′ having different widths may be used. In addition, forms of the optical film substantially laminated on the panel W may be sheet pieces F1 and F2 of the optical film corresponding to the shapes of one plane P1 and the other plane P2 of the panel W.

Hereinafter, an optical film which is laminated in the short edge (SE) longitudinal direction while being formed with a width corresponding to the long edge LE of the panel W will be described as a first optical film F1′ and an optical film which is laminated in the long edge (LE) longitudinal direction while being formed with a width corresponding to the short edge SE of the panel will be described as a second optical film F2′.

The first optical film F1′ and the second optical film F2′ may have optical pattern directions which are the same as each other in respective length directions. For example, each of the optical films F1′ and F2′ may include a polarization plate (not illustrated) in which an absorption axis is formed in the length direction.

Herein, since the first optical film F1′ is laminated on one plane of two planes of the panel W in the short edge (SE) longitudinal direction and the second optical film F2′ is laminated on the other plane of the two planes of the panel W in the long edge (LE) longitudinal direction, optical pattern directions of the first optical film F1′ and the second optical film F2′ may be disposed to be orthogonal to each other with the panel interposed therebetween.

The two types of optical display elements (the A type optical display element A and the B type optical display element B) which may be manufactured by a method and a system for manufacturing an optical display element according to an exemplary embodiment of the present invention may correspond to a so-called O-mode optical display element and a so-called E-mode optical display element, respectively according to a relationship between an initial alignment direction of the liquid crystal cell and an absorption axis direction of the polarizing plate included in the optical film laminated on one plane P1 of the panel W.

Herein, the “initial alignment direction of the liquid crystal cell” means an alignment direction of the liquid crystal cell when power is not applied to the optical display element.

Herein, the ‘O-mode optical display element’ means an optical display element in which the initial alignment direction of the liquid crystal cell and the absorption axis direction of the polarizing plate included in the optical film laminated on one plane P1 of the panel W are parallel to each other, and the ‘E-mode optical display element’ may mean an optical display element in which the initial alignment direction of the liquid crystal cell and the absorption axis direction of the polarizing plate included in the optical film laminated on one plane P1 of the panel W are orthogonal to each other.

In the present invention, the ‘parallel’ means not only mathematically parallel but also substantially parallel, and the angle thereof is generally within ±2, preferably within ±1° and more preferably within ±0.5°.

Further, the ‘orthogonal’ means not only mathematically orthogonal but also substantially orthogonal and the angle thereof is generally in a range of 90±2°, preferably 90±1°, and more preferably 90±0.5°.

In addition, the optical films F1′ and F2′ used in the present invention are stacked together with a release film and a surface protective film to form an optical film laminate. For example, an adhesive layer for laminating on the panel W is formed on one plane of the optical film, a release film for protecting the adhesive layer is formed, and a surface protective film may be formed on the other plane of the optical film by the adhesive layer interposed therebetween.

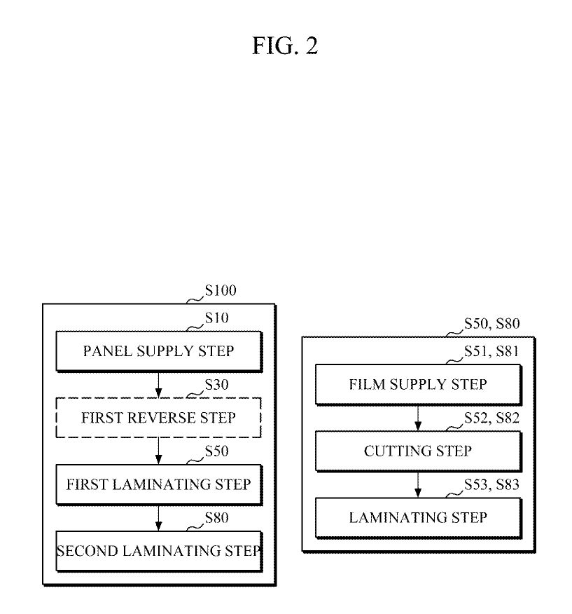

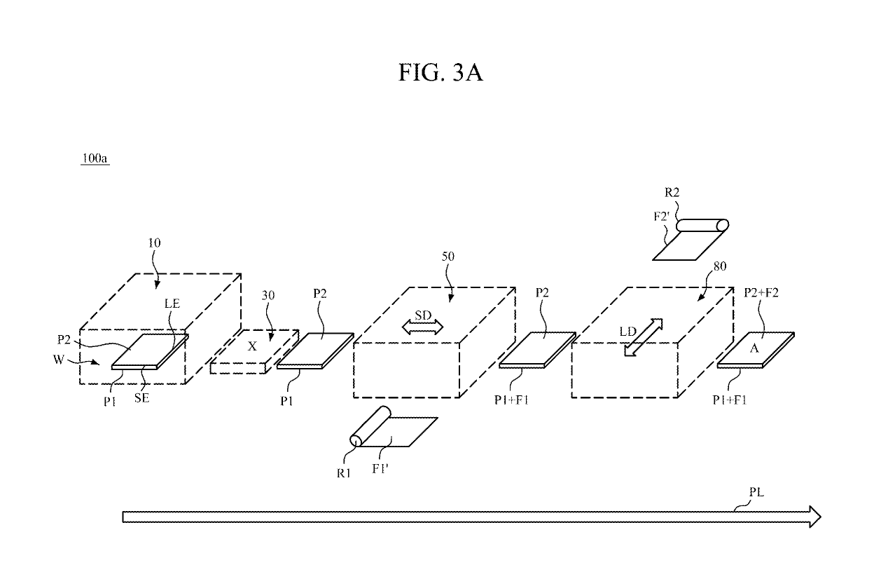

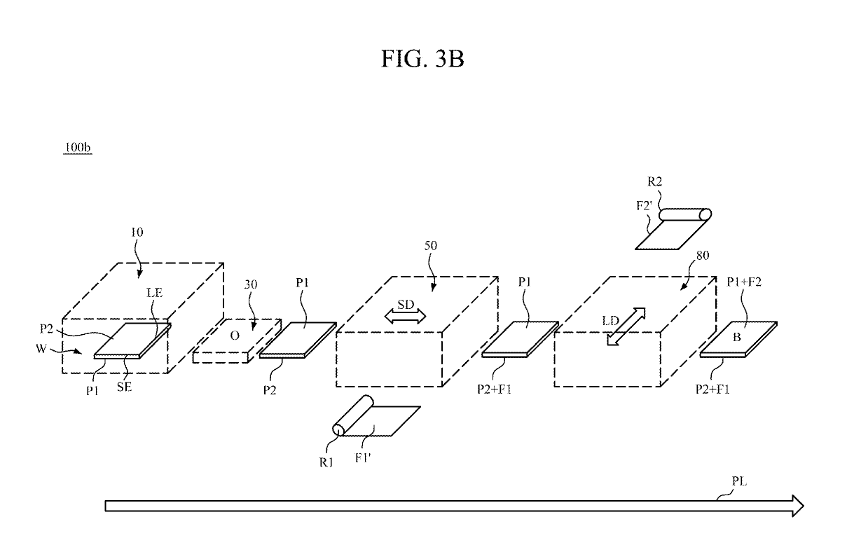

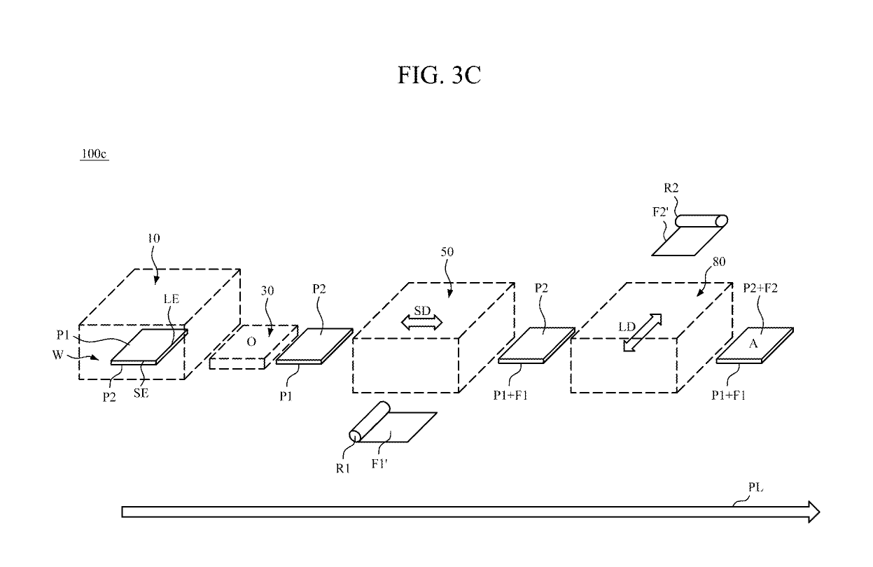

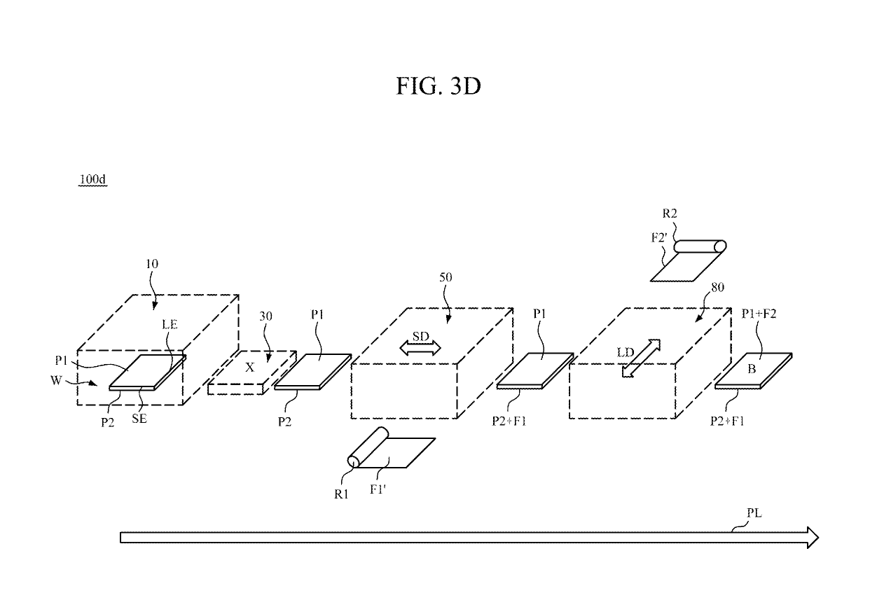

FIG. 2 is a block diagram illustrating an example of a method for manufacturing an optical display element according to an exemplary embodiment of the present invention, FIG. 3a is a schematic perspective view illustrating an example of manufacturing an A type optical display element by using the system for manufacturing an optical display element according to the exemplary embodiment of the present invention, FIG. 3b is a schematic perspective view illustrating an example of manufacturing a B type optical display element by using the system for manufacturing an optical display element according to an exemplary embodiment of the present invention, FIG. 3c is a schematic perspective view illustrating another example of manufacturing the A type optical display element by using the system for manufacturing an optical display element according to the exemplary embodiment of the present invention, and FIG. 3d is a schematic perspective view illustrating another example of manufacturing the B type optical display element by using the system for manufacturing an optical display element according to the exemplary embodiment of the present invention.

A method (S100) for manufacturing an optical display element according to an exemplary embodiment of the present invention, which manufactures an optical display elements A and B by laminating optical films F1 and F2 on both planes P1 and P2 of a rectangular panel W, may include a panel supply step (S10) of supplying the panel W; a first reverse step (S30) of selectively reversing the panel W; a first laminating step (S50) of laminating the optical film onto one plane of one plane P1 and the other plane P2 of the panel W; and a second laminating step (S80) of laminating the optical film onto the other plane of one plane P1 and the other plane P2 of the panel W.

Further, systems 100a to 100d for manufacturing an optical display element according to an exemplary embodiment of the present invention, as a system for manufacturing an optical display element, which manufactures optical display elements A and B by laminating optical films F1 and F2 on both planes P1 and P2 of a rectangular panel W, respectively, may include a panel supply unit 10; a first reverse unit 30; a first laminating unit 50; and a second laminating unit 80.

Herein, according to a configuration form of the system for manufacturing an optical display element in the present invention, a form (a straight line/a cross line) of a transport line PL of the panel W, the type of laminate of an optical film F1′/F2′ used in each of the first laminating step (S50) and the second laminating step (S80), a position (an upper side/a lower side of the panel W) of the upper side and the lower side of the panel W, at which the optical films F1 and F2 are laminated, and a supply direction (parallel to/crossing the transport line of the panel W) of the optical films F1 and F2 to the transport line PL of the panel W may be determined.

In the systems 100a to 100d for manufacturing an optical display element according to the exemplary embodiment of the present invention, the transport line PL of the panel W may be configured as a substantially straight line, an optical film laminate used in the first laminating unit 50 performing the first laminating step (S50) may be configured as the first optical film F1′, an optical film laminate used in the second laminating unit 80 performing the second laminating step (S80) may be configured as the second optical film F2′, a first side which is a position where the first optical film F1′ is laminated by the first laminating unit 50 between the upper side and the lower side of the panel W may be configured as the lower side of the panel W, a second side which is a position where the second optical film F2′ is laminated by the second laminating unit 80 between the upper side and the lower side of the panel W may be configured as the upper side of the panel W, a direction in which the first optical film F1′ is supplied by the first laminating unit 50 may be configured to be parallel to the transport line PL of the panel W, and a direction in which the second optical film F2′ is supplied by the second laminating unit 80 may be configured to cross the transport line PL of the panel W, as illustrated in FIGS. 3a to 3d.

In the method (S100) for manufacturing an optical display element and the systems 100a to 100d for manufacturing an optical display element according to an exemplary embodiment of the present invention, a panel supply plane which faces the lower side of the panel W between one plane P1 and the other plane P2 of the panel W supplied by the panel supply unit, a first laminating plane onto which the first optical film F1′ is laminated between one plane P1 and the other plane P2 of the panel W, and a second laminating plane onto which the second optical film F2′ is laminated may be previously set as the process conditions.

In the case of the systems 100a and 100b for manufacturing an optical display element, which are illustrated in FIGS. 3a and 3b, the process condition is set so that the panel supply plane which faces the lower side of the panel W between one plane P1 and the other plane P2 of the panel W supplied by the panel supply unit 10 becomes one plane P1 of the panel W.

On the contrary, in the case of the systems 100c and 100d for manufacturing an optical display element, which are illustrated in FIGS. 3c and 3d, the process condition is set so that the panel supply plane which faces the lower side of the panel W between one plane P1 and the other plane P2 of the panel W supplied by the panel supply unit becomes the other plane P2 of the panel W.

In the case of the systems 100a and 100c for manufacturing an optical display element, which are illustrated in FIGS. 3a and 3c, the process condition is set so that the first laminating plane onto which the first optical film F1′ needs to be laminated becomes one plane P1 of the panel W and the second laminating plane onto which the second optical film F2′ needs to be laminated becomes the other plane P2 of the panel W. That is, the process condition corresponds to a condition in which the A type optical display element A may be manufactured.

On the contrary, in the case of the systems 100b and 100d for manufacturing an optical display element, which are illustrated in FIGS. 3b and 3d, the process condition is set so that the first laminating plane onto which the first optical film F1′ needs to be laminated becomes the other plane P2 of the panel W and the second laminating plane onto which the second optical film F2′ needs to be laminated becomes one plane P1 of the panel W. That is, the process condition corresponds to a condition in which the B type optical display element B may be manufactured.

Herein, each of the two process conditions (the condition to manufacture the A type optical display element A/the condition to manufacture the B type optical display element B) may correspond to one of a condition to manufacture a so-called O mode optical display element and a condition to manufacture a so-called E mode optical display element, respectively according to a relationship between an initial alignment direction of liquid crystal cells and an absorption axis direction of a polarization plate included in the optical film laminated on one plane P1 of the panel W.

First, an example of manufacturing the two types of optical display elements will be described by using the method for manufacturing the optical display element and the system for manufacturing the optical display element according to the exemplary embodiments of the present invention based on FIGS. 2, and 3a and 3b.

In the panel supply step (S10), the panel W may be supplied to maintain a horizontal state by the panel supply unit 10. Herein, the panel supply unit 10 may supply the panel W so that the long-edge (LE) longitudinal direction of the panel W is parallel to the transport line PL of the panel W. The method may include a preliminary pivot step of pivoting the panel W so as to reverse the positional relationships of the long edge LE and the short edge SE of the panel W when the long-edge (LE) longitudinal direction of the panel W is orthogonal to the transport line PL of the panel W in an initial supply state of the panel W supplied by the panel supply unit 10.

In the systems 100a and 100b for manufacturing an optical display element, which are illustrated in FIGS. 3a and 3b, the panel W is supplied so that one plane P1 of the panel W faces the lower side of the panel W by the process condition determined so that the panel supply plane which faces the lower side of the panel W becomes one plane P1 of the panel W.

In the first reverse step (S30), when the set first laminating plane is different from the panel supply plane which faces the first side between one plane P1 and the other plane P2 of the panel W supplied by the panel supply unit 10, the panel W is reversed by the first reverse unit 30 so as to reverse the positional relationships of between one plane P1 and the other plane P2 of the panel W.

In the system 100a for manufacturing an optical display element, which is illustrated in FIG. 3a, by the process condition set so that the first laminating plane onto which the first optical film F1′ is laminated becomes one plane P1 of the panel W, the first laminating plane becomes one plane P1 of the panel W and the panel supply plane which faces the first side (the lower side of the panel W) also becomes one plane P1 of the panel W, in other words, the first laminating plane and the panel supply plane facing the first side coincide with each other, and as a result, the first reverse unit 30 does not reverse the panel W.

In the system 100b for manufacturing an optical display element, which is illustrated in FIG. 3b, by the process condition set so that the first laminating plane onto which the first optical film F1′ is laminated becomes the other plane P2 of the panel W, the first laminating plane becomes the other plane P2 of the panel W and the panel supply plane which faces the first side (the lower side of the panel W) becomes one plane P1, in other words, the first laminating plane and the panel supply plane facing the first side are different from each other, and as a result, the first reverse unit 30 reverses the panel W.

In other words, in the systems 100a and 100b for manufacturing an optical display element, which are illustrated in FIGS. 3a and 3b, since the first side which is the position onto which the first optical film F1′ is laminated by the first laminating unit 50 is configured to become the lower side of the panel W, when the process condition under which the B type optical display element B needs to be manufactured is previously set (100b), the panel W is reversed by the first reverse unit 30 so that the other plane P2 of the panel W, which is the first laminating plane faces the first side (the lower side of the panel W) at the time of transporting the panel W supplied by the panel supply unit 10 to the first laminating unit 50.

In the first laminating step S50, by the first laminating unit 50, the first optical film F1′ may be laminated in a first direction of the long-edge (LE) longitudinal direction and the short-edge (SE) longitudinal direction of the panel W at the first side of the upper side and the lower side of the panel W.

In the systems 100a and 100b for manufacturing an optical display element, which are illustrated in FIGS. 3a and 3b, since the first optical film F1′ is formed with a width corresponding to the long edge LE of the panel W, the first direction corresponds to the short-edge (SE) longitudinal direction and since the first laminating unit 50 is configured to laminate the first optical film F1′ at the lower side of the panel W in the short-edge (SE) longitudinal direction, the first side corresponds to the lower side of the panel W.

In the system 100a for manufacturing an optical display element, which are illustrated in FIG. 3a, as the case where the A type optical display element A needs to be manufactured, since one plane P1 of the panel W, which is the first laminating plane is transported to the first laminating unit 50 so as to face the first side (the lower side of the panel W) while the panel W is not reversed by the first reverse unit 30, the first laminating unit 50 laminates the first optical film F1′ onto one plane P1 of the panel W in the short-edge (SE) longitudinal direction.

In the system 100b for manufacturing an optical display element, which are illustrated in FIG. 3b, as the case where the B type optical display element B needs to be manufactured, since the panel W is reversed by the first reverse unit 30 and the other plane P2 of the panel W, which is the first laminating plane is thus transported to the first laminating unit 50 so as to face the first side (the lower side of the panel W), the first laminating unit laminates the first optical film F1′ onto the other plane P2 of the panel W in the short-edge (SE) longitudinal direction.

In the second laminating step S50, by the second laminating unit 80, the second optical film F2′ may be laminated on a plane (that is, the second laminating plane) opposite to the plane onto which the first optical film F1′ is laminated between one plane P1 and the other plane P2 of the panel W in a second direction different from the first direction between the long-edge (LE) longitudinal direction and the short-edge (SE) longitudinal direction of the panel W.

In the systems 100a and 100b for manufacturing an optical display element, which are illustrated in FIGS. 3a and 3b, since the second optical film F2′ is formed with the width corresponding to the short edge SE of the panel W, the second direction corresponds to the long-edge (LE) longitudinal direction and the second laminating unit 80 is configured to laminate the second optical film F2′ at the upper side of the panel W in the long-edge (LE) longitudinal direction.

In the system 100a for manufacturing an optical display element, which is illustrated in FIG. 3a, as the case in which the A type optical display element A needs to be manufactured, in the panel W after the first optical film F1′ is laminated onto one plane P1 by the first laminating unit 50, the other plane P2 of the panel W, which is the second laminating plane is transported to the second laminating unit 80 so as to face the upper side of the panel W and the second laminating unit 80 laminates the second optical film F2′ onto the other plane P2 of the panel W in the long-edge (LE) longitudinal direction.

As a result, the A type optical display element A may be manufactured, in which the optical film is laminated in the short-edge (SE) longitudinal direction based on one plane P1 of the panel W and the optical film is laminated in the long-edge (LE) longitudinal direction based on the other plane P2 of the panel W.

In the system 100b for manufacturing an optical display element, which is illustrated in FIG. 3b, as the case in which the B type optical display element B needs to be manufactured, in the panel W after the first optical film F1′ is laminated onto the other plane P2 by the first laminating unit 50, one plane P1 of the panel W, which is the second laminating plane is transported to the second laminating unit 80 so as to face the upper side of the panel W and the second laminating unit 80 laminates the second optical film F2′ onto one plane P1 of the panel W in the long-edge (LE) longitudinal direction.

As a result, the B type optical display element B may be manufactured, in which the optical film is laminated in the long-edge (LE) longitudinal direction based on one plane P1 of the panel W and the optical film is laminated in the short-edge (SE) longitudinal direction based on the other plane P2 of the panel W.

Herein, the first laminating step S50 and the second laminating step S80 may include film supply steps S51 and S81 of unrolling and supplying the optical films F1′ and F2′ from film rolls R1 and R2 on which the elongated optical films F1′ and F2′ are rolled, cutting steps S52 and S82 of cutting the optical films F1′ and F2′ unrolled and supplied from the film rolls R1 and R2 in a width direction to form optical film sheet pieces F1 and F2, and laminating steps S53 and S83 of laminating the optical film sheet pieces F1 and F2 on one plane of one plane P1 and the other plane P2 of the panel W.

In addition, in the film supply steps S51 and S81, the film rolls R1 and R2 may be provided in such a manner that a release film is bonded and wound on the optical films F1′ and F2′, in the cutting steps S52 and S82, the optical film sheet pieces F1 and F2 may be formed by cutting (so called, half-cutting) the optical films F1′ and F2′ in the width direction while the release film is not cut, and in the laminating steps S53 and S83, the optical film sheet pieces F1 and F2 are separated from the release film to be laminated onto one plane of one plane P1 and the other plane P2 of the panel W.

In the method and the system for manufacturing an optical display element according to an exemplary embodiment of the present invention, when the set first laminating plane is different from the panel supply plane which faces the first side (the position onto which the first laminating unit 10 laminates the first optical film F1′) between one plane P1 and the other plane P2 of the panel W supplied by the panel supply unit 10, the positional relationships of between one plane P1 and the other plane P2 of the panel W may be reversed to each other by the first reverse unit 30. Herein, since the first laminating plane is a process condition selectively set between one plane P1 and the other plane P2 of the panel W according to the types A and B of the optical display element to be manufactured, there is an advantage in that it is possible to manufacture two types of optical display elements (the A type optical display element A and the B type optical display element B) by a single manufacturing line.

Another example of manufacturing two types of optical display elements by using the systems 100c and 100d for manufacturing an optical display element according to the exemplary embodiments of the present invention will be described based on FIGS. 3c and 3d.

In the panel supply step (S10), in the systems 100c and 100d for manufacturing an optical display element, which are illustrated in FIGS. 3c and 3d, the panel W is supplied so that the other plane P2 of the panel W faces the lower side of the panel W by the process condition determined so that the panel supply plane which faces the lower side of the panel W becomes the other plane P2 of the panel W.

In the first reverse step (S30), in the system 100c for manufacturing an optical display element, which is illustrated in FIG. 3c, by the process condition set so that the first laminating plane onto which the first optical film F1′ is laminated becomes one plane P1 of the panel W, the first laminating plane becomes one plane P1 of the panel W and the panel supply plane which faces the first side (the lower side of the panel W) becomes the other plane P2 of the panel W, in other words, the first laminating plane and the panel supply plane facing the first side are different from each other, and as a result, the first reverse unit 30 reverses the panel W.

On the contrary, in the system 100d for manufacturing an optical display element, which is illustrated in FIG. 3d, by the process condition set so that the first laminating plane onto which the first optical film F1′ is laminated becomes the other plane P2 of the panel W, the first laminating plane becomes the other plane P1 of the panel W and the panel supply plane which faces the first side (the lower side of the panel W) also becomes the other plane P2 of the panel W, in other words, the first laminating plane and the panel supply plane facing the first side coincide with each other, and as a result, the first reverse unit 30 does not reverse the panel W.

In other words, in the systems 100c and 100d for manufacturing an optical display element, which are illustrated in FIGS. 3c and 3d, since the first side which is the position onto which the first optical film F1′ is laminated by the first laminating unit 50 is configured to become the lower side of the panel W, when the process condition in which the A type optical display element A needs to be manufactured is previously set (100c), the panel W is reversed by the first reverse unit 30 so that one plane P1 of the panel W which is the first laminating plane faces the first side (the lower side of the panel W) at the time of transporting the panel W supplied by the panel supply unit 10 to the first laminating unit 50.

Thereafter, in the first laminating step (S50) and the second laminating step (S80), in the system 100c for manufacturing an optical display element, which is illustrated in FIG. 3c, as the case where the A type optical display element A needs to be manufactured, the A type optical display element A is manufactured through the same process as the system 100a for manufacturing an optical display element, which is illustrated in FIG. 3a and in the system 100d for manufacturing an optical display element, which is illustrated in FIG. 3d, as the case where the B type optical display element B needs to be manufactured, the B type optical display element B is manufactured through the same process as the system 100b for manufacturing an optical display element, which is illustrated in FIG. 3b.

In the method and the system for manufacturing an optical display element according to the exemplary embodiments of the present invention, even though the process condition set so that the panel supply plane facing the lower side of the panel W between one plane P1 and the other plane P2 of the panel W supplied to the panel supply unit 10 becomes one plane P1 of the panel W is changed to the process condition set so that the panel supply plane becomes the other plane P2 of the panel W, when the set first laminating plane is different from the panel supply plane facing the first side (the position onto which the first laminating unit 10 laminates the first optical film F1′) between one plane P1 and the other plane P2 of the panel W supplied by the panel supply unit, the positional relationships of one plane P1 and the other plane P2 of the panel W may be reversed by the first reverse unit 30. Herein, since the first laminating plane is a process condition selectively set between one plane P1 and the other plane P2 of the panel W according to the types A and B of the optical display element to be manufactured, there is an advantage in that it is possible to manufacture two types of optical display elements (the A type optical display element A and the B type optical display element B) by the single manufacturing line.

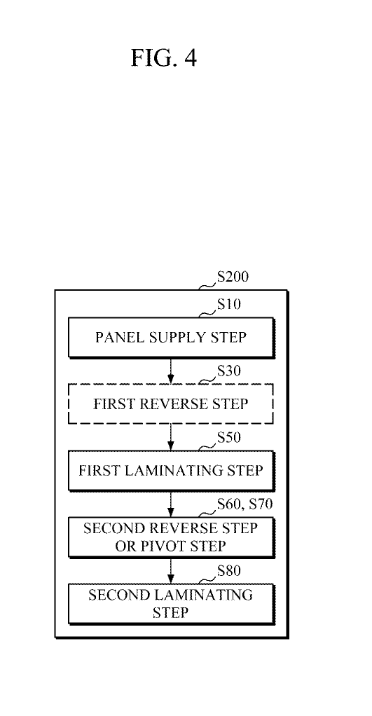

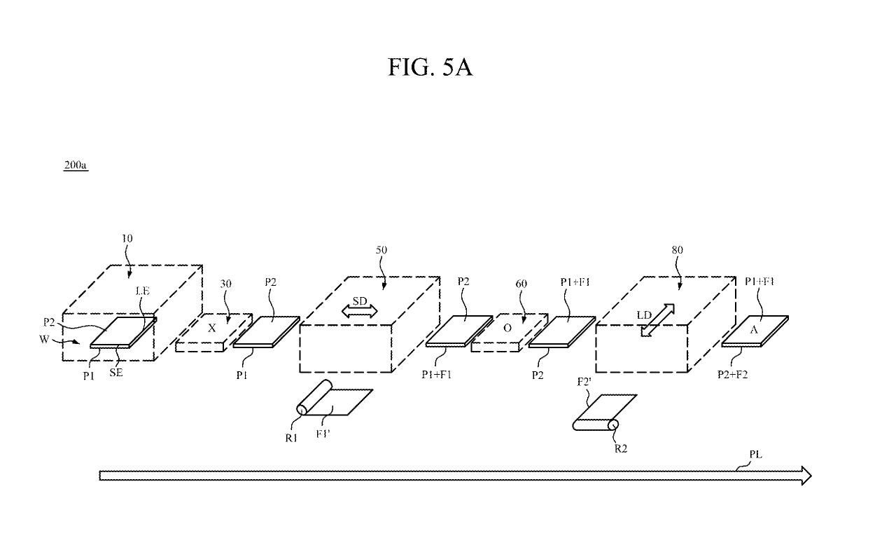

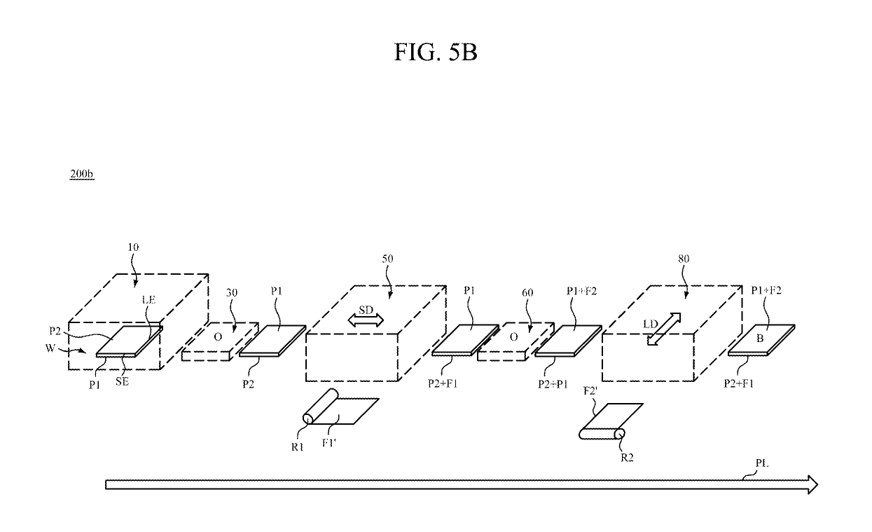

FIG. 4 is a block diagram illustrating an example of a method for manufacturing an optical display element according to fourth to third exemplary embodiments of the present invention, FIGS. 5a to 7a are schematic perspective views illustrating an example of manufacturing an A type optical display element by using a system for manufacturing an optical display element according to the second to fourth exemplary embodiments of the present invention, and FIGS. 5b to 7b are schematic perspective views illustrating an example of manufacturing a B type optical display element by using the system for manufacturing an optical display element according to the second to fourth exemplary embodiments of the present invention.

A method (S200) for manufacturing an optical display element according to second to fourth exemplary embodiments of the present invention, which manufactures an optical display elements A and B by laminating optical films F1′ and F2′ on both planes P1 and P2 of a rectangular panel W, may include a panel supply step (S10) of supplying the panel W; a first reverse step (S30) of selectively reversing the panel W; a first laminating step (S50) of laminating the optical film onto one plane of one plane P1 and the other plane P2 of the panel W; a second reverse step (S60) of reversing the panel W or a pivot step (S70) of pivoting the panel W; and a second laminating step (S70) of laminating the optical film onto the other plane of one plane P1 and the other plane P2 of the panel W.

Further, the systems 100a to 100d for manufacturing an optical display element according to the second to fourth exemplary embodiments of the present invention, as the systems for manufacturing an optical display element, which manufacture the optical display elements A and B by laminating the optical films F1 and F2 on both planes P1 and P2 of a rectangular panel W, respectively, may include a panel supply unit 10; a first reverse unit 30; a first laminating unit 50; a second reverse unit 60 or pivot unit 70; and a second laminating unit 80.

In the systems 200a to 200b for manufacturing an optical display element according to the second exemplary embodiment of the present invention, the transport line PL of the panel W may be configured as a substantially straight line, an optical film laminate used in the first laminating unit 50 performing the first laminating step (S50) may be configured as the first optical film F1′, an optical film laminate used in the second laminating unit 80 performing the second laminating step (S80) may be configured as the second optical film F2′, a first side which is a position where the first optical film F1′ is laminated by the first laminating unit 50 between the upper side and the lower side of the panel W may be configured as the lower side of the panel W, a second side which is a position where the second optical film F2′ is laminated by the second laminating unit 80 between the upper side and the lower side of the panel W may be also configured as the lower side of the panel W, a direction in which the first optical film F1′ is supplied by the first laminating unit 50 may be configured to be parallel to the transport line PL of the panel W, and a direction in which the second optical film F2′ is supplied by the second laminating unit 80 may be configured to cross the transport line PL of the panel W, as illustrated in FIGS. 5a and 5b.

In the case of the systems 200a and 200b for manufacturing an optical display element, which are illustrated in FIGS. 5a and 5b, the process condition is set so that the panel supply plane which faces the lower side of the panel W between one plane P1 and the other plane P2 of the panel W supplied by the panel supply unit 10 becomes one plane P1 of the panel W.

In the case of the system 200a for manufacturing an optical display element, which are illustrated in FIG. 5a, the process condition is set so that the first laminating plane onto which the first optical film F1′ needs to be laminated becomes one plane P1 of the panel W and the second laminating plane onto which the second optical film F2′ needs to be laminated becomes the other plane P2 of the panel W. That is, the process condition corresponds to a condition in which the A type optical display element A may be manufactured.

On the contrary, in the case of the system 200b for manufacturing an optical display element, which is illustrated in FIG. 5b, the process conditions are set in such a manner that the first laminating plane onto which the first optical film F1′ needs to be laminated becomes the other plane P2 of the panel W and the second laminating plane onto which the second optical film F2′ needs to be laminated becomes one plane P1 of the panel W. That is, the process condition corresponds to a condition in which the B type optical display element B may be manufactured.

The panel supply step S10 to the first laminating step S50 of the second exemplary embodiment pass through mostly the same process as the panel supply step S10 to the first laminating step S50 in the first exemplary embodiment.

In detail, in the panel supply step S10 to the first laminating step S50, as a case in which the system 200a for manufacturing an optical display element, which is illustrated in FIG. 5a needs to manufacture the A type optical display element A, the system 200a passes through the same process as the optical display element manufacturing system 100a illustrated in FIG. 3a and as a case in which the system 300b for manufacturing an optical display element illustrated in FIG. 5b needs to manufacture the B type optical display element B, the system 300b passes through the same process as the optical display element manufacturing system 100b illustrated in FIG. 3b.

In the second reverse step (S60) of the second exemplary embodiment, before the second optical film F2′ is laminated onto the panel W, the panel W may be reversed by the second reverse unit 60 so that directions which one plane P1 and the other plane P2 of the panel W after the first optical film F1′ is laminated face are reversed to each other.

As the case where the system 200a for manufacturing an optical display element, which is illustrated in FIG. 5a needs to manufacture the A type optical display element A, the process condition is set so that the second laminating plane onto which the second optical film F2′ is laminated becomes the other plane P2 of the panel W and in the panel W after the first optical film F1′ is laminated, the second laminating plane becomes the other plane P2 of the panel W, while the panel plane facing the second side (the lower side of the panel W) becomes one plane P1 of the panel W, in other words, the second laminating plane and the panel plane facing the second side are different from each other. In this case, when the panel W laminated with the first optical film F1′ is transported to the second laminating unit 80, the panel W is reversed by the second reverse unit 60 so that the other surface P2 of the panel W, which is the second laminating plane, faces the second side (the lower side of the panel W).

As the case where the system 200b for manufacturing an optical display element, which is illustrated in FIG. 5B needs to manufacture the B type optical display element B, the process condition is set so that the second laminating plane onto which the second optical film F2′ is laminated becomes one plane P1 of the panel W and in the panel W after the first optical film F1′ is laminated, the second laminating plane becomes one plane P1 of the panel W, while the panel plane facing the second side (the lower side of the panel W) becomes the other plane P2 of the panel W, in other words, the second laminating plane and the panel plane facing the second side are different from each other. In this case, when the panel W laminated with the first optical film F1′ is transported to the second laminating unit 80, the panel W is reversed by the second reverse unit so that one P1 of the panel W, which is the second laminating plane, faces the second side (the lower side of the panel W).

The second laminating step S80 in the second exemplary embodiment is mostly the same as the second laminating step S80 in the exemplary embodiment in terms of components and effects and the second laminating unit 80 in the second exemplary embodiment is configured to laminate the second optical film F2′ in the long-edge (LE) longitudinal direction at the lower side of the panel W.

In the system 200a for manufacturing an optical display element, which is illustrated in FIG. 5A, as the case in which the A type optical display element A needs to be manufactured, after the first optical film F1′ is laminated onto one plane P1 by the first laminating unit 50, the panel W is reversed by the second reverse unit 60 and the other plane P2 of the panel W, which is the second laminating plane, is thus transported to the second laminating unit 80 so as to face the lower side of the panel W and the second laminating unit 80 laminates the second optical film F2′ onto the other plane P2 of the panel W in the long-edge (LE) longitudinal direction. As a result, the A type optical display element A may be manufactured, in which the optical film is laminated in the short-edge (SE) longitudinal direction based on one plane P1 of the panel W and the optical film is laminated in the long-edge LE longitudinal direction based on the other plane P2 of the panel W.

In the system 200b for manufacturing an optical display element, which is illustrated in FIG. 5b, as the case in which the B type optical display element B needs to be manufactured, after the first optical film F1′ is laminated onto the other plane P2 by the first laminating unit 50, the panel W is reversed by the second reverse unit 60 and one plane P1 of the panel W, which is the second laminating plane, is thus transported to the second laminating unit 80 so as to face the lower side of the panel W and the second laminating unit 80 laminates the second optical film F2′ onto one plane P1 of the panel W in the long-edge (LE) longitudinal direction.

As a result, the B type optical display element B may be manufactured, in which the optical film is laminated in the long-edge (LE) longitudinal direction based on one plane P1 of the panel W and the optical film is laminated in the short-edge (SE) longitudinal direction based on the other plane P2 of the panel W.

In accordance with the optical display element manufacturing systems 200a and 200b according to the second exemplary embodiment of the present invention, two types of optical display elements (the A type optical display element A and the B type optical display element B) may be manufactured by the single manufacturing line and the optical display element manufacturing system includes the second reverse unit 60, and as a result, both positions at which the first optical film F1′ and the second optical film F2′ are laminated with respect onto the panel W may be configured to become the lower side of the panel W to reduce the size of the entire manufacturing system and minimize inflow of foreign materials, which may occur while laminating as compared with the case where the optical film is laminated at the upper side of the panel W.

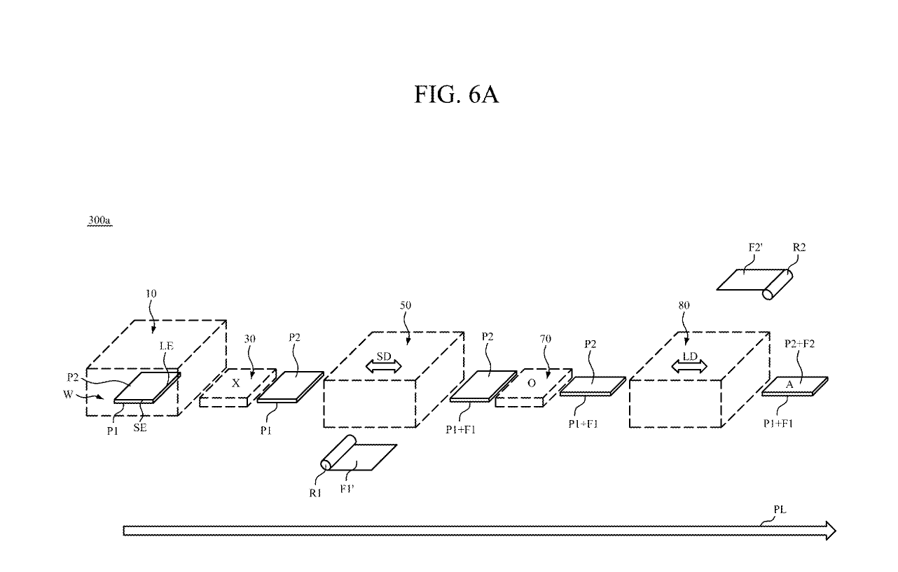

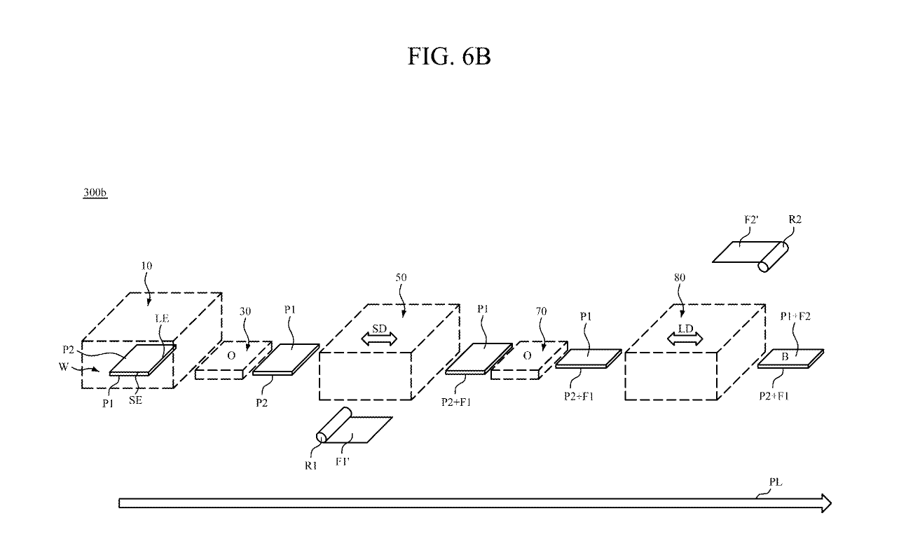

In the systems 300a and 300b for manufacturing an optical display element according to the third exemplary embodiment of the present invention, the transport line PL of the panel W may be configured as a substantially straight line, an optical film laminate used in the first laminating unit 50 performing the first laminating step (S50) may be configured as the first optical film F1′, an optical film laminate used in the second laminating unit 80 performing the second laminating step (S80) may be configured as the second optical film F2′, a first side which is a position where the first optical film F1′ is laminated by the first laminating unit 50 between the upper side and the lower side of the panel W may be configured as the lower side of the panel W, a second side which is a position where the second optical film F2′ is laminated by the second laminating unit 80 between the upper side and the lower side of the panel W may be configured as the upper side of the panel W, a direction in which the first optical film F1′ is supplied by the first laminating unit 50 may be configured to be parallel to the transport line PL of the panel W, and a direction in which the second optical film F2′ is supplied by the second laminating unit 80 may also be configured to be parallel to the transport line PL of the panel W, as illustrated in FIGS. 6a and 6b.

In the case of the systems 300a and 300b for manufacturing an optical display element, which are illustrated in FIGS. 6A and 6B, the process condition is set in such a manner that the panel supply plane which faces the lower side of the panel W between one plane P1 and the other plane P2 of the panel W supplied by the panel supply unit 10 becomes one plane P1 of the panel W.

In the case of the system 300a for manufacturing an optical display element, which are illustrated in FIG. 6a, the process condition is set so that the first laminating plane onto which the first optical film F1′ needs to be laminated becomes one plane P1 of the panel W and the second laminating plane onto which the second optical film F2′ needs to be laminated becomes the other plane P2 of the panel W. That is, the process condition corresponds to a condition in which the A type optical display element A may be manufactured.

On the contrary, in the case of the system 300b for manufacturing an optical display element, which are illustrated in FIG. 6b, the process condition is set so that the first laminating plane onto which the first optical film F1′ needs to be laminated becomes the other plane P2 of the panel W and the second laminating plane onto which the second optical film F2′ needs to be laminated becomes one plane P1 of the panel W. That is, the process condition corresponds to a condition in which the B type optical display element B may be manufactured.

The panel supply step S10 to the first laminating step S50 of the third exemplary embodiment pass through mostly the same process as the panel supply step S10 to the first laminating step S50 in the first exemplary embodiment.

In detail, in the panel supply step S10 to the first laminating step S50, as a case in which the system 300a for manufacturing an optical display element, which is illustrated in FIG. 6a needs to manufacture the A type optical display element A, the system 300a passes through the same process as the optical display element manufacturing system 100a illustrated in FIG. 3a and as a case in which the system 300b for manufacturing an optical display element illustrated in FIG. 6b needs to manufacture the B type optical display element B, the system 200b passes through the same process as the optical display element manufacturing system 100b illustrated in FIG. 3b.

In the pivot step (S70) of the third exemplary embodiment, before the second optical film F2′ is laminated onto the panel W, the panel W may be reversed by the pivot unit 70 so that the positional relationships between the long edge LE and the short edge SE of the panel W after the first optical film F1′ is laminated face are reversed to each other.

As the case where the system 300a for manufacturing an optical display element, which is illustrated in FIG. 6a needs to manufacture the A type optical display element A, the process condition is set so that the second laminating plane onto which the second optical film F2′ is laminated becomes the other plane P2 of the panel W, a direction in which the second optical film F2′ is supplied by the second laminating unit 80 is configured to be parallel to the transport line PL of the panel W, and the second laminating unit 80 is configured to laminate the second optical film F2′ at the upper side of the panel W.

Meanwhile, in the panel W after the first optical film F1′ is laminated, the second laminating plane becomes the other plane P2 of the panel W and the panel facing the second side (the upper side of the panel W) also becomes the other plane P2 of the panel W, in other words, the second laminating plane and the panel plane facing the second side are the same as each other, but the long-edge (LE) longitudinal direction of the panel W, which is a direction in which the second optical film F2′ needs to be laminated and a direction in which the second optical film F2′ is supplied by the second laminating unit 80 cross (are orthogonal to) each other. In this case, when the panel W onto which the first optical film F1′ is laminated is transported to the second laminating unit 80, the panel W is pivoted by the pivot unit 70 so that the long-edge (LE) longitudinal direction of the panel, which is the direction in which the second optical film F2′ needs to be laminated and the direction in which the second optical film F2′ is supplied by the second laminating unit 80 are parallel to each other.

As the case where the system 300b for manufacturing an optical display element, which is illustrated in FIG. 6b needs to manufacture the B type optical display element B, the process condition is set so that the second laminating plane onto which the second optical film F2′ is laminated becomes one plane P1 of the panel W, the direction in which the second optical film F2′ is supplied by the second laminating unit 80 is configured to be parallel to the transport line PL of the panel W, and the second laminating unit 80 is configured to laminate the second optical film F2′ at the upper side of the panel W.

Meanwhile, in the panel W after the first optical film F1′ is laminated, the second laminating plane becomes one plane P1 of the panel W and the panel plane facing the second side (the upper side of the panel W) also becomes one plane P1 of the panel W, in other words, the second laminating plane and the panel facing the second side are the same as each other, but the long-edge (LE) longitudinal direction of the panel W, which is the direction in which the second optical film F2′ needs to be laminated and the direction in which the second optical film F2′ is supplied by the second laminating unit 80 cross (are orthogonal to) each other. In this case, when the panel W onto which the first optical film F1′ is laminated is transported to the second laminating unit 80, the panel W is pivoted by the pivot unit 70 so that the long-edge (LE) longitudinal direction of the panel, which is the direction in which the second optical film F2′ needs to be laminated and the direction in which the second optical film F2′ is supplied by the second laminating unit 80 are parallel to each other.

The second laminating step S80 in the third exemplary embodiment is mostly the same as the second laminating step S80 in the exemplary embodiment in terms of components and effects, the direction in which the second optical film F2′ is supplied by the second laminating unit 80 is configured to be parallel to the transport line PL of the panel W, and the second laminating unit 80 is configured to laminate the second optical film F2′ in the long-edge (LE) longitudinal direction at the upper side of the panel W.

As the case where the system 300a for manufacturing an optical display element, which is illustrated in FIG. 6a needs to manufacture the A type optical display element A, after the first optical film F1′ is laminated onto one plane P1 by the first laminating unit 50, the panel W is pivoted by the pivot unit 70 and thus transported to the second laminating unit 80 while the long-edge (LE) longitudinal direction of the panel W, which is the direction in which the second optical film F2′ needs to be laminated and the direction in which the second optical film F2′ is supplied by the second laminating unit 80 are parallel to each other and the second laminating unit 80 laminates the second optical film F2′ onto the other plane P2 of the panel W in the long-edge (LE) longitudinal direction.

As a result, the A type optical display element A may be manufactured, in which the optical film is laminated in the short-edge (SE) longitudinal direction based on one plane P1 of the panel W and the optical film is laminated in the long-edge LE longitudinal direction based on the other plane P2 of the panel W.

As the case where the system 300b for manufacturing an optical display element, which is illustrated in FIG. 6b needs to manufacture the B type optical display element B, after the first optical film F1′ is laminated onto the other plane P2 by the first laminating unit 50, the panel W is pivoted by the pivot unit 70 and thus transported to the second laminating unit 80 while the long-edge (LE) longitudinal direction of the panel W, which is the direction in which the second optical film F2′ needs to be laminated and the direction in which the second optical film F2′ is supplied by the second laminating unit 80 are parallel to each other and the second laminating unit 80 laminates the second optical film F2′ onto one plane P1 of the panel W in the long-edge (LE) longitudinal direction.

As a result, the B type optical display element B may be manufactured, in which the optical film is laminated in the long-edge (LE) longitudinal direction based on one plane P1 of the panel W and the optical film is laminated in the short-edge (SE) longitudinal direction based on the other plane P2 of the panel W.

In accordance with the optical display element manufacturing systems 300a and 300b according to the third exemplary embodiment of the present invention, two types of optical display elements (the A type optical display element A and the B type optical display element B) may be manufactured by a single manufacturing line and the optical display element manufacturing system includes the second pivot unit 70, and as a result, both supply directions of the first optical film F1′ and the second optical film F2′ to the panel W may be configured to be parallel to the transport line PL of the panel W and the transport line PL of the panel W and supply lines of the optical films F1′ and F2′ are configured in a straight form to reduce a total system size.

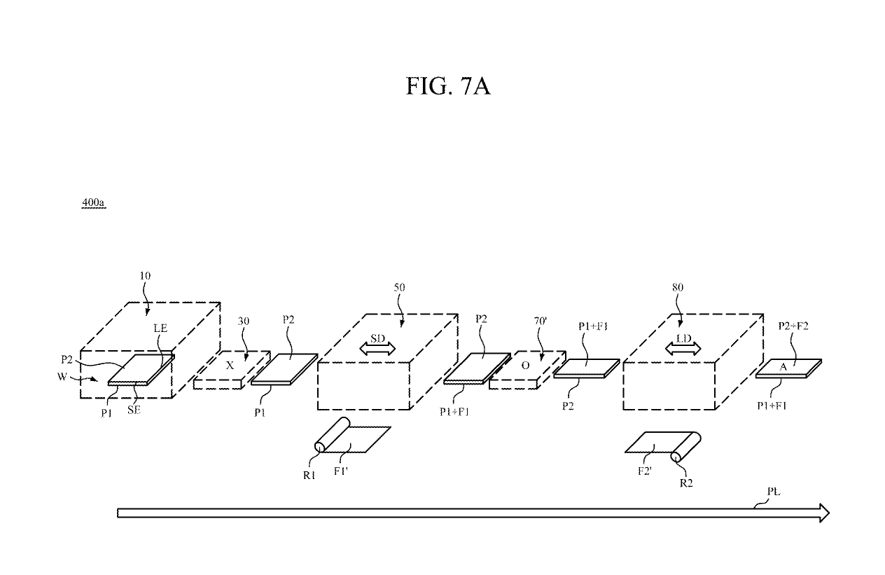

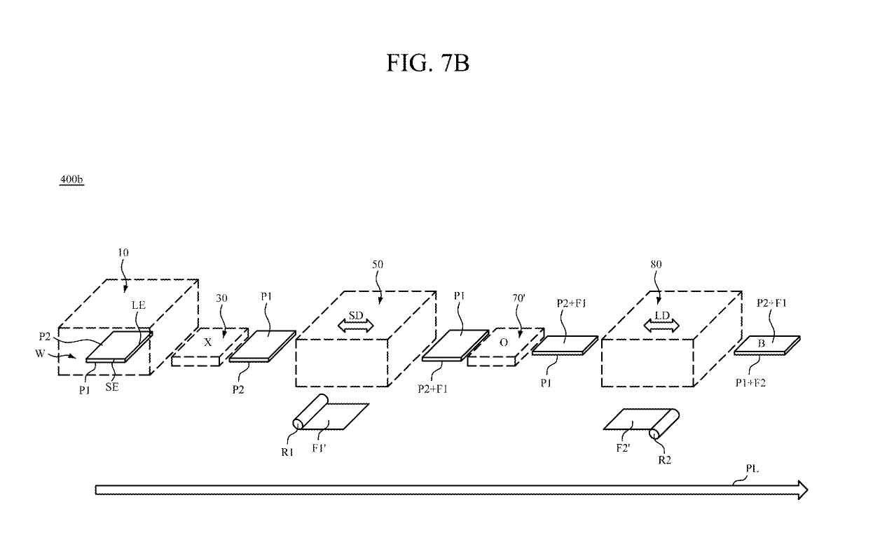

In the systems 400a and 400b for manufacturing an optical display element according to the fourth exemplary embodiment of the present invention, the transport line PL of the panel W may be configured as a substantially straight line, an optical film laminate used in the first laminating unit 50 performing the first laminating step (S50) may be configured as the first optical film F1′, an optical film laminate used in the second laminating unit 80 performing the second laminating step (S80) may be configured as the second optical film F2′, a first side which is a position where the first optical film F1′ is laminated by the first laminating unit 50 between the upper side and the lower side of the panel W may be configured as the lower side of the panel W, a second side which is a position where the second optical film F2′ is laminated by the second laminating unit 80 between the upper side and the lower side of the panel W may also be configured as the upper side of the panel W, a direction in which the first optical film F1′ is supplied by the first laminating unit 50 may be configured to be parallel to the transport line PL of the panel W, and a direction in which the second optical film F2′ is supplied by the second laminating unit 80 may be configured to be parallel to the transport line PL of the panel W, as illustrated in FIGS. 7a and 7b.

In the case of the systems 400a and 400b for manufacturing an optical display element, which are illustrated in FIGS. 7a and 7b, the process condition is set in such a manner that the panel supply plane which faces the lower side of the panel W between one plane P1 and the other plane P2 of the panel W supplied by the panel supply unit 10 becomes one plane of P1 of the panel W.

In the case of the system 400a for manufacturing an optical display element, which are illustrated in FIG. 7a, the process condition is set so that the first laminating plane onto which the first optical film F1′ needs to be laminated becomes one plane P1 of the panel W and the second laminating plane onto which the second optical film F2′ needs to be laminated becomes the other plane P2 of the panel W. That is, the process condition corresponds to a condition in which the A type optical display element A may be manufactured.

On the contrary, in the case of the system 400b for manufacturing an optical display element, which are illustrated in FIG. 7b, the process condition is set so that the first laminating plane onto which the first optical film F1′ needs to be laminated becomes the other plane P2 of the panel W and the second laminating plane onto which the second optical film F2′ needs to be laminated becomes one plane P1 of the panel W. That is, the process condition corresponds to a condition in which the B type optical display element B may be manufactured.

The panel supply step S10 to the first laminating step S50 of the fourth exemplary embodiment pass through mostly the same process as the panel supply step S10 to the first laminating step S50 in the first exemplary embodiment.

In detail, in the panel supply step S10 to the first laminating step S50, as a case in which the system 400a for manufacturing an optical display element, which is illustrated in FIG. 7a needs to manufacture the A type optical display element A, the system 400a passes through the same process as the optical display element manufacturing system 100a illustrated in FIG. 3a and as a case in which the system 400b for manufacturing an optical display element illustrated in FIG. 7b needs to manufacture the B type optical display element B, the system 400b passes through the same process as the optical display element manufacturing system 100b illustrated in FIG. 3b.

In the pivot step (S70) of the fourth exemplary embodiment, before the second optical film F2′ is laminated onto the panel W, the panel W may be pivoted by a pivot unit 70′ around a pivot axis C which is parallel to both planes P1 and P2 of the panel W and is not parallel to any edge of the long edge LE and the short edge SE of the panel W so that the positional relationships of the long edge LE and the short edge SE of the panel W after the first optical film F1′ is laminated are reversed to each other and the directions which one plane P1 and the other plane P2 face are reversed to each other.

As the case where the system 400a for manufacturing an optical display element, which is illustrated in FIG. 7a needs to manufacture the A type optical display element A, the process condition is set so that the second laminating plane onto which the second optical film F2′ is laminated becomes the other plane P2 of the panel W, a direction in which the second optical film F2′ is supplied by the second laminating unit 80 is configured to be parallel to the transport line PL of the panel W, and the second laminating unit 80 is configured to laminate the second optical film F2′ at the lower side of the panel W.

Meanwhile, in the panel W after the first optical film F1′ is laminated, the second laminating plane becomes the other plane P2 of the panel W, while the panel facing the second side (the lower side of the panel W) becomes one plane P1 of the panel W, in other words, the second laminating plane and the panel plane facing the second side are different from each other and the long-edge (LE) longitudinal direction of the panel W, which is the direction in which the second optical film F2′ needs to be laminated and the direction in which the second optical film F2′ is supplied by the second laminating unit 80 cross (are orthogonal to) each other. In this case, when the panel W onto which the first optical film F1′ is laminated is transported to the second laminating unit 80, the panel W is pivoted by the pivot unit 70′ so that the long-edge (LE) longitudinal direction of the panel, which is the direction in which the second optical film F2′ needs to be laminated and the direction in which the second optical film F2′ is supplied by the second laminating unit 80 are parallel to each other and the other plane P2 of the panel W, which is the second laminating plane faces the second side (the lower side of the panel W).

As the case where the system 400b for manufacturing an optical display element, which is illustrated in FIG. 7b needs to manufacture the B type optical display element B, the process condition is set so that the second laminating plane onto which the second optical film F2′ is laminated becomes one plane P1 of the panel W, the direction in which the second optical film F2′ is supplied by the second laminating unit 80 is configured to be parallel to the transport line PL of the panel W, and the second laminating unit 80 is configured to laminate the second optical film F2′ at the lower side of the panel W.

Meanwhile, in the panel W after the first optical film F1′ is laminated, the second laminating plane becomes one plane P1 of the panel W, while the panel facing the second side (the lower side of the panel W) becomes the other plane P2 of the panel W, in other words, the second laminating plane and the panel facing the second side are different from each other, but the long-edge (LE) longitudinal direction of the panel W, which is the direction in which the second optical film F2′ needs to be laminated and the direction in which the second optical film F2′ is supplied by the second laminating unit 80 cross (are orthogonal to) each other. In this case, when the panel W onto which the first optical film F1′ is laminated is transported to the second laminating unit 80, the panel W is pivoted by the pivot unit 70′ so that the long-edge (LE) longitudinal direction of the panel, which is the direction in which the second optical film F2′ needs to be laminated and the direction in which the second optical film F2′ is supplied by the second laminating unit 80 are parallel to each other and one plane P1 of the panel W, which is the second laminating plane faces the second side (the lower side of the panel W).

The second laminating step S80 in the fourth exemplary embodiment is mostly the same as the second laminating step S80 in the exemplary embodiment in terms of components and effects, the direction in which the second optical film F2′ is supplied by the second laminating unit 80 is configured to be parallel to the transport line PL of the panel W, and the second laminating unit 80 is configured to laminate the second optical film F2′ in the long-edge (LE) longitudinal direction at the lower side of the panel W.

As the case where the system 300a for manufacturing an optical display element, which is illustrated in FIG. 7a needs to manufacture the A type optical display element A, after the first optical film F1′ is laminated onto one plane P1 by the first laminating unit 50, the panel W is pivoted by the pivot unit 70′ and thus transported to the second laminating unit 80 while the long-edge (LE) longitudinal direction of the panel W, which is the direction in which the second optical film F2′ needs to be laminated and the direction in which the second optical film F2′ is supplied by the second laminating unit 80 are parallel to each other and the other plane P2 of the panel W, which is the second laminating plane faces the lower side of the panel W, and the second laminating unit 80 laminates the second optical film F2′ onto the other plane P2 of the panel W in the long-edge (LE) longitudinal direction.

As a result, the A type optical display element A may be manufactured, in which the optical film is laminated in the short-edge (SE) longitudinal direction SD based on one plane P1 of the panel W and the optical film is laminated in the long-edge LE longitudinal direction LD based on the other plane P2 of the panel W.

As the case where the system 300b for manufacturing an optical display element, which is illustrated in FIG. 7b needs to manufacture the B type optical display element B, after the first optical film F1′ is laminated onto the other plane P2 by the first laminating unit 50, the panel W is pivoted by the pivot unit 70′ and thus transported to the second laminating unit 80 so that the long-edge (LE) longitudinal direction of the panel W, which is the direction in which the second optical film F2′ needs to be laminated and the direction in which the second optical film F2′ is supplied by the second laminating unit 80 are parallel to each other and one plane P1 of the panel W, which is the second laminating plane faces the lower side of the panel W, and the second laminating unit 80 laminates the second optical film F2′ onto one plane P1 of the panel W in the long-edge (LE) longitudinal direction.

As a result, the B type optical display element B may be manufactured, in which the optical film is laminated in the long-edge LE longitudinal direction based on one plane P1 of the panel W and the optical film is laminated in the short-edge SE longitudinal direction based on the other plane P2 of the panel W.

In accordance with the optical display element manufacturing systems 400a and 400b according to the fourth exemplary embodiment of the present invention, two types of optical display elements (the A type optical display element A and the B type optical display element B) may be manufactured by a single manufacturing line and the optical display element manufacturing system includes the pivot unit 70, and as a result, both supply directions of the first optical film F1′ and the second optical film F2′ to the panel W may be configured to be parallel to the transport line PL of the panel W and the transport line PL of the panel W and supply lines of the optical films F1′ and F2′ are configured in a straight form to reduce a total system size and both positions of the panel W onto which the first and second optical films F1′ and F2′ are laminated may be set to the lower side of the panel W to minimize introduction of foreign materials which may be generated while laminating as compared with the case of laminating the optical film at the upper side of the panel W.

The aforementioned description of the present invention is to be exemplified, and it can be understood by those skilled in the art that the technical spirit or required features of the present invention can be easily modified in other detailed forms without changing the technical spirit or requisite features of the present invention. Therefore, it should be appreciated that the aforementioned embodiments are illustrative in all aspects and are not restricted. For example, respective constituent elements described as single types can be distributed and implemented, and similarly, constituent elements described to be distributed can also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

1. A system for manufacturing an optical display element, which manufactures an optical display element by laminating optical films on both planes of a rectangular panel, the system comprising:
a panel supply unit supplying the panel;
a first laminating unit laminating a first optical film onto the panel in a first direction selected from a long-edge longitudinal direction and a short-edge longitudinal direction of the panel at a first side selected from the two sides of the panel;
a second laminating unit laminating a second optical film onto a plane opposite to the plane onto which the first optical film is laminated in a second direction selected from the long-edge longitudinal direction and the short-edge longitudinal direction of the panel and different from the first direction; and
a first reverse unit reversing, when a first laminating plane onto which the first optical film is laminated is selected from between one plane and the other plane of the panel and predetermined as a process condition, the panel to reverse positional relationships of the planes of the panel if the first laminating plane is different from a plane of the panel supplied by the panel supply unit at the first side of the panel.

2. The system of claim 1, wherein in the optical display element, the panel includes liquid crystal cells and one plane of the panel is disposed at a light source of the liquid crystal cells.

3. The system of claim 2, wherein the optical film includes the polarization plate, and
in the process condition, the first laminating plane is set so that an initial alignment direction of the liquid crystal cells is parallel to the absorption axis direction of the polarization plate included in the optical film laminated onto one plane of the panel.

4. The system of claim 2, wherein the optical film includes the polarization plate, and
in the process condition, the first laminating plane is set so that an initial alignment direction of the liquid crystal cells is orthogonal to the absorption axis direction of the polarization plate included in the optical film laminated onto one plane of the panel.

5. The system of claim 1, further comprising:
a second reverse unit reversing the panel so as to reverse the directions toward which the planes of the panel onto which the first optical film is laminated face, before the second optical film is laminated onto the panel.

6. The system of claim 1, further comprising:
a pivot unit pivoting the panel so as to reverse the positional relationships of a long edge and a short edge of the panel onto which the first optical film is laminated, before the second optical film is laminated onto the panel.

7. The system of claim 6, wherein the pivot unit pivots the panel around a pivot axis which is parallel to both planes of the panel and is not parallel to either of the long edge and the short edge of the panel so as to reverse directions which the planes of the panel onto which the first optical film is laminated face.

8. The system of claim 1, wherein a first optical film sheet piece formed by unrolling the first optical film from a first film roll on which the first optical film which elongates is wound and cutting the first optical film in a width direction is laminated onto one plane of the planes of the panel, and
a second optical film sheet piece formed by unrolling a second optical film from a second film roll on which the second optical film which has a different width from the first optical film and elongates is wound and cutting the second optical film in the width direction is laminated onto a plane opposite to the plane of the panel onto which the first optical film sheet piece is laminated to manufacture the optical display element.

9. A method for manufacturing an optical display element, which manufactures an optical display element by laminating optical films on both planes of a rectangular panel, the method comprising:
supplying the panel by a supply unit;
laminating a first optical film onto the panel in a first direction selected from a long-edge longitudinal direction and a short-edge longitudinal direction of the panel at a first side at a first side selected from the two sides of the panel by a first laminating unit;
laminating a second optical film onto a plane opposite to the plane onto which the first optical film is laminated in a second direction selected from the long-edge longitudinal direction and the short-edge longitudinal direction of the panel and different from the first direction by a second laminating unit; and
reversing, when a first laminating plane onto which the first optical film is laminated between one plane and the other plane of the panel is previously set as a process condition, the panel to reverse positional relationships of the planes of the panel by a first reverse unit if the first laminating plane is different from a plane of the panel supplied by the panel supply unit at the first side of the panel.

10. The method of claim 9, wherein in the optical display element, the panel includes liquid crystal cells and one plane of the panel is disposed at a light source of the liquid crystal cells.

11. The method of claim 10, wherein the optical film includes a polarization plate, and
in the process condition, the first laminating plane is set so that an initial alignment direction of the liquid crystal cells is parallel to the absorption axis direction of the polarization plate included in the optical film laminated onto one plane of the panel.

12. The method of claim 10, wherein the optical film includes a polarization plate, and
in the process condition, the first laminating plane is set so that an initial alignment direction of the liquid crystal cells is orthogonal to the absorption axis direction of the polarization plate included in the optical film laminated onto one plane of the panel.

13. The method of claim 9, further comprising:
reversing by the second reverse unit the panel so as to reverse directions toward which the planes of the panel onto which the first optical film is laminated face, before the second optical film is laminated onto the panel.

14. The method of claim 9, further comprising:
pivoting the panel by a pivot unit so as to reverse the positional relationships of a long edge and a short edge of the panel onto which the first optical film is laminated, before the second optical film is laminated onto the panel.

15. The method of claim 14, wherein in the pivoting, the pivot unit pivots the panel around a pivot axis which is parallel to both planes of the panel and is not parallel to either of the long edge and the short edge of the panel so as to reverse directions toward which the planes of the panel onto which the first optical film is laminated face.

16. The method of claim 9, wherein a first optical film sheet piece formed by unrolling the first optical film from a first film roll on which the first optical film which elongates is wound and cutting the first optical film in a width direction is laminated onto one plane of the planes of the panel, and
a second optical film sheet piece formed by unrolling a second optical film from a second film roll on which the second optical film which has a different width from the first optical film and elongates is wound and cutting the second optical film in the width direction is laminated onto a plane opposite to the plane of the panel onto which the first optical film is laminated to manufacture the optical display element.
